(19) United States
(12) Patent Application Publication
(10) Pub. No.: US 2006/0059063 A1
(43) Pub. Date: Mar. 16, 2006

(54) Methods and systems for visualizing financial anomalies

(76) Inventors: Christina Ann LaComb, Schenectady, NY (US); Bethany Kniffin Hoogs, Niskayuna, NY (US); Jason Paul Miele, Falls Church, VA (US); Deniz Senturk Doganaksoy, Niskayuna, NY (US); Radu Eugen Neagu, Schenectady, NY (US); Corey Nicholas Bufi, Troy, NY (US); Abha Moitra, Scotia, NY (US); Andrew Isaac Deitsch, Clifton Park, NY (US); Richard Brownell Arthur, Ballston Spa, NY (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 11/028,685

(22) Filed: Jan. 5, 2005

Related U.S. Application Data
(60) Provisional application No. 60/599,511, filed on Aug. 6, 2004.

(51) Int. Cl. G06Q 40/00

(52) U.S. Cl. 705/35

(57) ABSTRACT

A visualization technique for directing the attention of analysts to anomalous values of performance measures associated with a target entity is described. A grid of cells is created where each row represents a particular performance metric, and each column a particular time period. For each cell, an anomaly score is calculated associated with the performance metric and time period corresponding to the row and column of the cell. The anomaly score is based on the value of the performance metric for that particular entity for that time period, as well as context data. The context data is selected to represent the historical values of the performance metric for the target entity or the simultaneous performance of peer entities. The anomaly score is calculated using an exceptional statistical technique, and a display characteristic is associated with the value of the anomaly score based upon the range into which the anomaly score falls. The display characteristic is displayed within the cell on the grid, forming an anomaly map that allows identification of patterns among the performance metrics.

### RELATED CASE

This application claims priority under 35 U.S.C. §119(e) from Provisional Application No. 60/599,511 filed on 6 Aug. 2004.

### TECHNICAL FIELD

The systems and techniques described herein relate generally to displaying data for analysis. More specifically, these systems and techniques relate to a data presentation to draw attention to anomalies within a set of related performance data.

### BACKGROUND

The role of an analyst is generally to examine data associated with a particular entity, and to use that data to more completely understand the entity. This understanding can then be used to evaluate the entity, or to make plans for how to improve the performance of the entity, or compare entities to one another. Examples of such analysis include: the examination of medical records to determine to what degree a treatment on a patient (or group of patients) has been effective; examination of athletic performance by a coach to determine how best to improve the performance of the players; examination of historical failure data to determine optimal insurance rates for particular insured equipment; and examination of historical financial data to evaluate the financial health of a target company.

Taking this last example, understanding the financial health of a company is an important factor in evaluating a potential business interaction with that company. An understanding of a company's financial health can be used to help evaluate the risks involved in doing business with that company, and can form a basis for predicting the expected benefits from the potential business relationship or transaction. However, fraudulent financial filings by the company can provide a misleading picture of the financial health of a company. Companies that engage in such fraudulent financial behavior can collapse in ways not reflected by the apparent financial health reflected by their financial information.

As a result of recent collapses of companies that were hiding their financial difficulties behind fraudulent financial data, investors and creditors are seeking ways to identify false or misleading financials before the time where the company's dire financial straits become apparent due to earnings shortfalls, scandals or bankruptcy. Even when financial data is available that can be used to evaluate whether or not there are warning signs that could be found within the financial data, it can be a difficult process to identify where and to what degree the financial data presented is anomalous or merits further investigation or consideration.

Therefore, there is a continued need for improvement in the presentation of data to facilitate evaluation of performance associated with the data of a target entity and to facilitate comparison between entities.

### BRIEF SUMMARY OF THE DISCLSOURE

In one embodiment of the systems and methods provided herein, a method for displaying anomaly measures associated with a target entity is presented. Each anomaly measure is associated with a performance metric and a time period, and for each metric, the method involves: determining a value for an anomaly score associated with the metric; determining a set of ranges of anomaly scores; associating a displayable characteristic with each of the set of ranges; assigning a displayable characteristic to each anomaly score based on the range into which the anomaly score falls; associating the displayable characteristic for that anomaly score with a cell on a grid, the cell being associated with the particular anomaly measure and time period of the corresponding performance metric; and presenting the data on a display medium. The set of ranges are selected such that the total range of possible anomaly scores is divided into a set such that each range in the set is separated from an adjacent range by a breakpoint.

In another embodiment of the systems and methods described, the target entity is a company, and the performance metrics are financial metrics representing the financial results of the target company.

In another embodiment of the systems and methods described, anomaly scores are determined by identifying a target value; collecting context data on the target entity; and calculating an anomaly score using the target value and context data using an exceptional statistical measurement. The target value is the value of the performance metric associated with the target entity for a specific time period.

In a further embodiment of the systems and methods described, calculating an anomaly score includes the steps of generating a measure of central tendency for the target value and context data using an exceptional technique; generating a measure of variation for the target value and context data using an exceptional technique; and generating an anomaly score based on the measure of central tendency, the measure of variation, and the target value.

In another embodiment of the systems and methods described herein, the anomaly score is generated using an equation of the form

$$A = \frac{Xt - CT}{V}$$

where A is the anomaly score, Xt is the target value, CT is the measure of central tendency, and V is the measure of the variation.

In another embodiment of the systems and methods described herein, the breakpoints between the ranges of anomaly score values can be adjusted, collectively, in order to alter the center of the ranges and the size of the ranges.

In another embodiment of the systems and techniques described, a visualization of a set of anomaly measures associated with a target entity is created. Each of the set of anomaly measures is associated with a performance metric and a time period, and the visualization comprises a grid of cells; a set of ranges of anomaly scores; and a set of displayable characteristics. The grid of cells is disposed on a display medium and arranged into rows and columns such that each cell belongs to one row and one column. Each cell in a particular row or column corresponds to either the same performance metric or the same time period. An anomaly score associated with the target entity, time period and performance metric corresponding to the row and column of the cell is associated with the cell. The displayable characteristic associated with the range into which the anomaly score falls is associated with the cell and displayed on the display medium at the location of the cell.

### BRIEF DESCRIPTION OF THE DRAWINGS

The above mentioned and other features will now be described with reference to the drawings of embodiments of the visualizations. The drawings are intended to illustrate, but not to limit, the embodiments described. The drawings contain the following figures:

FIG. 1 is an exemplary visualization showing an anomaly map associated with the financial metrics of a target company;

FIG. 2 is another exemplary visualization showing a red flag map associated with a target company; and

FIG. 3 illustrates schematically a set of controls to adjust the centering and sensitivity of the anomaly map visualization of FIG. 1.

### DETAILED DESCRIPTION

As noted above, analysts examine data and improve the understanding of the entities represented by the data in order to more effectively manage tasks related to that entity. In general, analysis can comprise examining historical data associated with the performance of various aspects of a particular entity. Such historical data can come from many sources and in many forms. One common form is numerical data that represents measurements of various aspects of the performance of the entity. These measurements are referred to as ‘performance metrics’. In general, any historical result that can be represented as a number associated with that result can be considered a performance metric.

Generally, a performance metric is associated with a specific period of time. For instance, a common type of measurement that is carried out on automobiles involves determining how many kilometers that the car can travel for each liter of fuel that is burned. This particular performance metric, kilometers-per-liter, can be calculated on the basis of a particular trip, a particular time period, or a particular tank of fuel. The particular value that is calculated may vary depending on the time period associated with the metric. For example, over a lifetime of operation, a car may get 10 kilometers-per-liter, while when measured over a specific time period, for example, June 2003 to August 2003, the kilometers-per-liter may be 12.

A technique will be described for representing performance metrics associated with a particular entity. One goal of these techniques is to allow someone who is performing the analysis to more quickly focus on the most significant portions of the data, and to more effectively evaluate the entity being described by the performance metric data.

In particular, a series of examples will be discussed giving details of the operation of various systems and techniques for providing visualizations to aid in analysis of data. The particular examples discussed below are related to financial analysis. As a result, the entities being examined are target companies operating in various industries, and they are measured using a variety of financial performance metrics, as will be discussed in further detail below. However, it will be understood that the systems and techniques discussed are applicable to entities in many other fields of analysis, each of which may use its own particular performance metrics. These may include, but are not limited to: long term health-care analysis of health metrics (analyzing measurements of blood pressure, weight, white blood cell count, and so on); medical research (analyzing measurements of organ function, blood chemistry or other treatment specific measurements); mechanical equipment performance (measurement of time between failures, downtime, availability, cost to repair failures, and so on); television ratings performance (number of households viewing, advertising revenue per half-hour, intent-to-view tracking, cost of production per half-hour, and so on); and athletic performance and statistics (defensive yards given up per game, batting average, win-loss ratio, and so on).

Financial analysts, such as managers of investment portfolios, analysts working for companies extending credit, and loan officers, make decisions everyday based on perceptions of a company's financial health. Their basis for this perception is generally in large part taken from information on the company's financial statement. Taken at its simplest, such financial analysts look for any financial data that doesn't seem to fit in, either because it represents an unusual financial circumstance for the company (which may indicate poor financial health), or because it doesn't conform to the analyst's existing knowledge of the company's financial circumstances (which may indicate improper or fraudulent financial reporting).

Such ‘out of the ordinary’ financial data is referred to generally as an ‘anomaly’. A financial analyst would like to be able to recognize any financial anomalies, and to determine the significance of these anomalies as quickly and effectively as possible. Properly recognized and understood, financial anomalies can act as early warning signs of financial decline or fraud, which can allow an analyst to undertake the appropriate detailed investigation and consideration necessary to the proper evaluation of business transactions with companies exhibiting such anomalous finances. Such evaluation may help avoid transactions that are undesirable by recognizing developing problems before they happen, or by shaping the terms of agreements to take into account the nature of the anomalies detected.

In the discussion of the described systems and techniques below, the particular company of interest to a financial analyst or other investigator is referred to as the ‘target’ company. The target company is evaluated by determining values for one or more financial metrics and comparing these values to financial metric values for either: (a) the same company at earlier times; or (b) peer companies to the target company. These comparisons are used to generate a visual representation of the variations between the metrics for the target company and its historical performance and peers.

As discussed herein, a ‘financial metric’ may be any piece of financial data that is associated with the performance or operation of a company over a particular time period. For instance, a classic financial metric is net income. Other financial metrics include, but are not limited to: total revenue; inventory on hand; capital expenses; interest payments; debt; and earnings before interest, taxes, depreciation and amortization (EBITDA). While these and many other financial metrics are known in the art, their usage to identify financial anomalies has become progressively more difficult over time. As financial accounting has become increasingly complex, it has become more difficult to systematically identify financial statement fraud or financial decline.

Even when a broad scope of well-considered financial metrics is used to analyze the financial health of a target company, it can still be difficult to rapidly determine whether a particular value of a metric indicates a cause for further investigation or reconsideration of a potential business transaction or not. For example, knowing that a company generated 1.4 million dollars worth of sales last year is of little use without other indicia for comparison. Therefore, rather than simply learning the value of the metric, the analyst would like to determine whether the financial metric's value is out of the ordinary for the company, i.e. whether the metric is anomalous. The definition of an anomaly may change from one financial metric to the next. Limitations on anomalous values may also vary based on factors such as target company size, the industry in which the target company operates, and with the passage of time. In particular, changes over time can reflect both changes in the operation of the company, as well as changes in the overall economic environment.

In order to account for these variations and determine whether or not a given value for a financial metric for a target company is outside an expected range (i.e., anomalous), context information is used to form a basis for the analysis of the target company's financial metric data. As noted above, this context information can be taken from two primary sources: the target company's past performance, and the performance of the target company's peers. By using such context information to quantify the typical amount of variation present within the industry or within the company's own performance, it is possible to systematically and rigorously compare current financial metric data to context data and accurately assess the level of anomalous financial data in the target company's financial statements. In particular, the techniques described herein are well suited to identifying anomalous values in small sets of data. This can be significant because the amount of context data that is appropriate and relevant is often limited.

As noted above, context information is used to properly evaluate the degree to which a given financial metric is anomalous. In order to have an effective evaluation, the context data is selected to be appropriately relevant to the target financial metric for the target company. When selecting the appropriate context data over the time domain, it is generally desirable to look at the closest data available to the time period of interest. Since the time period of interest is usually the most recent data available, the appropriate scope of time to consider is a sequence of the most recent financial data available for the company—for example, the scope might correspond to the last 3 years of data.

Proper context data that accounts for the financial behavior of the industry and overall economic environment is found by using an appropriate group of ‘peer’ companies to the target company. A group of companies from the same industry and of similar size is selected to act as the appropriate peer group for the target company. “Similar size” may be determined by comparing one or more of a variety of indices of size. In one particular embodiment, “similar size” is determined by total sales. It will be understood that a variety of measurements, including the financial metrics themselves, can be used as the index of size. It is generally desirable to choose the peer group such that the target company lies in the middle of the group as measured by the selected index of size. This provides equal representation in the peer group of companies that are larger and smaller than the target company.

In a further particular embodiment, the peer companies may be selected from the group of companies that are classified within the same Standard Industrial Code (SIC) as the target company. If a database of companies with appropriate financial data is available, such as the database of information made available by Mergent, Inc., the peer group can be selected to be the companies in the database in the same SIC as the target company, and exhibiting the next four highest and next four lowest values for the index of size, e.g., total sales. It will be understood that other sized groups of similarly sized companies can be chosen, but that as noted above, it may be desirable to maintain a group of peer companies to both sides of the target company's size when possible.

In the event that there are not four companies that exhibit indices of size greater than the target company, it can often be effective to compare metrics that have been normalized by the appropriate size metric. For instance, if an analyst were using a target metric of outstanding debt to evaluate a target company, each peer company's debt could be normalized by being divided by that company's total assets, for example. Other financial metrics could also be used for normalization, including but not limited to total revenue or market capitalization.

By establishing the appropriate context, both in time and across the industry to the peers of the target company, the need for a subjective assessment as to whether a given financial metric is anomalously high or low can be avoided, and objective and automatic calculation can be made to detect and quantify financial anomalies.

Note that a financial metric's value can be either anomalously high, or anomalously low. While there generally is a particular direction that is recognized as being the preferable trend in a value (e.g., it is generally better to have high revenues than low revenues), it should be noted that this technique is designed to identify and quantify anomalies regardless of their polarity. This allows for the evaluation of data that appears to be too good to be trusted and may in fact represent a misleading or suspicious value for a financial metric. It also can be significant for detection of anomalies identified by simultaneous behavior of more than one financial metric. However, as will be discussed in greater detail below, the display of anomalous data will differ depending on whether the anomaly is in a positive or a negative direction.

In order to quantify the degree and direction of anomalousness associated with a particular value for a particular target company, statistical analysis of the value of the metric for that company can be carried out in comparison to: (a) a body of data representing the past behavior of that metric for the company; or (b) the behavior of that metric compared to the corresponding metric for peer companies to the target company. This comparison can be used to associate a score representing the degree of anomalousness associated with a particular value in comparison to the population to which it is being compared. This score can be calculated in various ways, some of which are discussed further below.

Such an ‘anomaly score’ for each financial metric for the target company can be calculated. For a given target company, each financial metric can be analyzed to determine the degree to which the value for that metric is different from the appropriate context data for that company and that metric. Depending on the nature of the context used (i.e., over time as opposed to across an industry), there are two different types of anomaly scores that can be calculated: the ‘anomaly-within’ score, and the ‘anomaly-between’ score.

‘Anomaly-within’ scores are scores calculated based upon the set of data representing a particular financial metric for a target company taken over different time periods. For instance, this data may represent financial metrics from successive fiscal quarters. The target value is generally the most recent value of the metric. In this way, anomaly-within scores measure a given company's financial data against its own past performance.

‘Anomaly-between’ scores are scores based upon the set of data for a given financial metric taken for a target company and a group of peer companies, all for the same time period. This data may represent the performance of a group of similarly situated companies all considered in a particular fiscal quarter. The anomaly-between scores measure a given company's financial data against the performance of its peer group.

The financial metrics that can be used to calculate these anomaly scores can include any of the financial metrics discussed herein, and may be taken from any source that provides appropriate data for comparison. These sources can include, but are not limited to: balance sheets, income statements, and cash flow statements, as well as metrics that are output by other financial analysis techniques.

Such information can be manually located and collated, or can be identified automatically. In addition to techniques known in the art for reading and analyzing sources of financial data, additional techniques that may be of use are described in copending U.S. patent application Ser. No. 10/401,310 entitled “Mathematical Decomposition of Table-Structured Electronic Documents” (Attorney Docket 126304) filed on 27 Mar. 2003, copending U.S. patent application Ser. No. 10/400,982 entitled “Automated Understanding and Decomposition of Table-Structured Electronic Documents” (Attorney Docket 126305) filed on 27 Mar. 2003, and copending U.S. patent application Ser. No. 10/401,259 entitled “Automated Understanding, Extraction and Structured Reformatting of Information in Electronic Files” (Attorney Docket 126311) filed on 27 Mar. 2003, the entirety of all of which is hereby incorporated by reference herein.

As noted above, one statistical technique to evaluate the degree to which a particular value in a group is an outlier, i.e. is anomalous, is to calculate what is known as a ‘z-score’ for the value in the group. Typical z-scores are based upon a calculation of the mean and the standard deviation of the group, and the technique for calculating z-scores is well known in the art. While such a statistical technique can be effective in evaluating the degree to which a single entry is anomalous in a well-populated group, z-scores can be shown to lose their effectiveness as an indication of anomalousness when used on sets of data that have only a few values. This lack of discriminating power with small data sets limits the utility of a z-score in many types of analysis discussed herein.

As a result, while it is possible to use z-scores as anomaly scores, it is often not desirable to do so. Therefore, while anomaly scores need not be z-scores, they may still use certain elements that are similar to those used in calculating the z-score. For instance, standard z-scores are based on a measurement of the central tendency of the group, and the variation within the group. In calculating a z-score, the central tendency is represented by the mean of the group, while the variation is represented by the standard deviation of the group. Such generalized elements such as central tendency and variation for the group can be useful in defining more effective anomaly scores.

The anomaly score calculation may be generally of the form

$$A = \frac{Xt - CT}{V} \qquad ( Equation 1 )$$

where A is the anomaly score, Xt represents the target value, CT represents a measure of central tendency of the set, and V represents a measure of the variation in the set.

As will be understood by those of skill in the art, the measure of central tendency may include any number of different calculations that describe the central tendency of the set of values, including but not limited to: mean, geometric mean, median, and mode. Similarly, those of skill in the art will appreciate that any of a variety of measures of variation may be used as well, including but not limited to: range, variance, standard deviation, coefficient of variance, and standard error. It will also be understood that the measurements of central tendency and variation may be based on more than one of the types of calculations, for instance, the measure of central tendency could be a weighted average of the mean and the mode, based upon the number of occurrences of the mode value among the data.

A set of techniques based upon the use of ‘exceptional’ statistical calculations are described herein that enable financial analysts to perform the desired forms of analysis on small sets of data, while retaining the ability to identify anomalous values within that small set. In general, an ‘exceptional’ technique, also referred to herein as an exceptional statistical technique, an exceptional measurement or an exceptional calculation, may be defined as a technique for calculating a statistical value associated with a set of data and a target value, such that the target value is excluded from the calculation of the exceptional measurement. Examples will be discussed in greater detail below. By using an exceptional technique, the particular target value within a group is prevented from skewing the measurements used to characterize that group.

As noted above, ‘exceptional’ measurements for central tendency and variation are used in one embodiment of an effective anomaly score calculation. In particular embodiments, techniques making use of the ‘exceptional mean’ and the ‘exceptional deviation’ are used.

In accordance with the definition provided above, the ‘exceptional mean’ is the mean of a set of data, excluding the target value. For example, consider the set of five values comprising 4, 5, 12, 13, and 16. The ordinary mean of this set of data is 10 (the sum of the values is 50, which when divided by the number of values, yields 10). However, the exceptional mean for this set of data, when the third value, 12, is the target value, is 9.5 (the sum of the four values in the set excluding the target value is 38, which when divided by the number of values excluding the target value, yields 9.5).

In a similar manner, the ‘exceptional deviation’ is the standard deviation of the set of data when the target value is excluded from the set of data. For example, consider the set of five values discussed above: 4, 5, 12, 13, and 16. The ordinary standard deviation is calculated by taking the square root of the variance about the mean of the group (in this case, the standard deviation is approximately 5.2). However, if the target value we are using in our anomaly score is the third value (i.e., 12), then the exceptional deviation is the standard deviation of the set comprising: 4, 5, 13 and 16 (approximately 5.9).

Note that the exceptional mean and exceptional deviation for a group may change depending upon which value in the group is the target value. Also note that in our example above, the exceptional mean is smaller than the ordinary mean, while the exceptional deviation is larger than the standard deviation.

As mentioned above, the use of context allows for the central tendency and variation used in the calculation of an anomaly score to vary based upon changes in the context data. By creating such sensitivity to changes over time within the target company, as well as sensitivity to variations in the particular industry of the target company, the anomaly score may be more effective at reflecting the degree that a given metric is a true outlier, and not merely indicative of a larger trend that includes the target company. More details and a further discussion of anomaly scores and exceptional statistical measures can be found in co-pending patent application “METHODS AND SYSTEMS FOR ANOMALY DETECTION IN SMALL DATASETS”, application Ser. No. ______ (Attorney Docket 137267), the entirety of which is hereby incorporated by reference herein.

The detection of anomalies, however, is less effective if they are not relayed to account managers or other investment professionals in a way that motivates them to take appropriate investigative action. One mode for communicating the scope and nature of the anomalies present within the financial metrics of a target company is to prepare a visual display, or ‘visualization’, of the anomalies associated with the target company.

Such a visualization can be used to direct the attention of the account manager or other decision maker to those aspects of a particular target company that are most in need of more detailed investigation and evaluation to determine the potential impact and underlying cause of the identified financial anomalies. The technical effect of these presentation techniques is to allow the identification of the severity, frequency, and even the underlying causes of anomalous conditions, and to illustrate the relationship between identified anomalies. All of this information can be used to help draw conclusions about the risk of fraud, default or financial instability associated with the target company. Furthermore, appropriate visualizations may be used to compare the results from different target companies in order to assess relative strengths and risks of those companies.

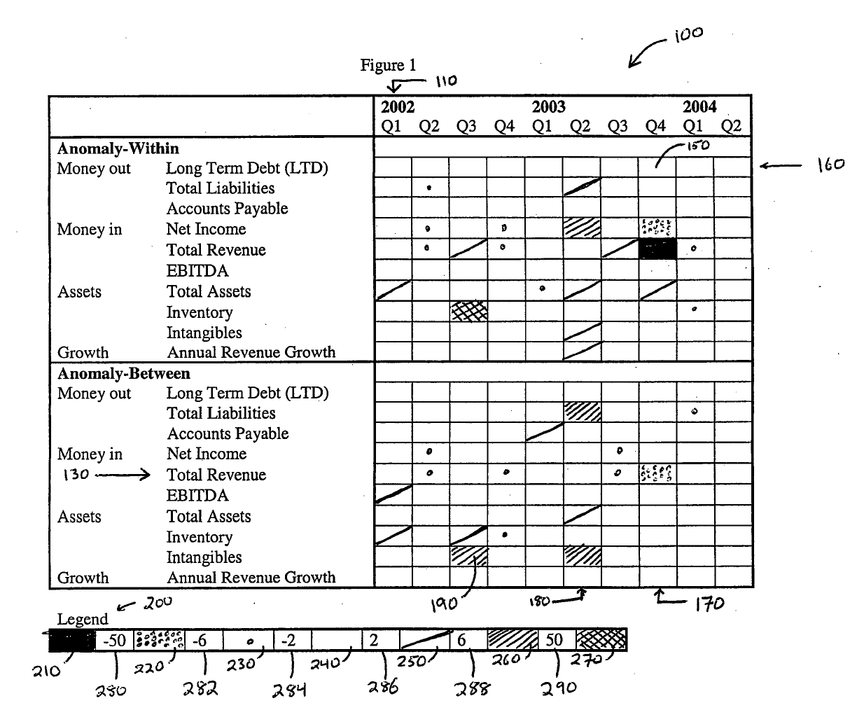

One particular embodiment of a visualization is illustrated in FIG. 1 and discussed below. FIG. 1 presents what will be referred to as an ‘anomaly map’ for a particular target company. The illustrated anomaly map 100 is presented as a table with rows and columns, and a body of cells formed at the intersection of each row and column.

In this embodiment, each column generally represents one time period associated with the financial metrics being analyzed. As discussed above, this period may vary based on the availability of the financial metric data, and need not correspond to a specific length of time for every anomaly map. In the illustrated anomaly map 100, each column corresponds to a single fiscal quarter. For instance, column 110 represents the financial metrics associated with the first fiscal quarter of 2002. While ten columns representing periodic data are included in FIG. 1, those of skill in the art will understand that any number of columns can be used as appropriate for the historical extent of the financial data available for analysis.

In the embodiment of FIG. 1, each row of the body of the anomaly map represents a particular financial metric that was evaluated for the target company. For instance, in FIG. 1, row 130 represents the financial metric of Total Revenue. A separate row may be used for each different financial metric evaluated, and the number of rows need not be limited to the number shown in FIG. 1, but may be selected to correspond to the number of different financial metrics considered for the target company.

With each column representing a time period, and each row representing a financial metric, the cells within the body of the anomaly map each represent the financial metric of the cell's row when evaluated for the target company in the time period associated with the cell's column. For instance, cell 150 represents the financial metric of “Long Term Debt” associated with row 160, for the time period of the fourth fiscal quarter of 2003, which is associated with column 170.

As noted above, anomaly scores that can be of especial use in directing the attention of a decision maker to the most relevant portions of an anomaly map can generally be divided into the categories of ‘anomaly-within’ and ‘anomaly-between’ scores. It is generally desirable to include both anomaly-within and anomaly-between scores on an anomaly map, and various arrangements can be used to do so.

In the illustrated example of FIG. 1, a technique that places all anomaly-within scores in a single portion of the anomaly map is used. All anomaly-between scores are then placed in a separate portion of the map. As will be understood by those of skill in the art, the choice of display technique may depend upon the display medium to be used.

Another approach to the presentation of these scores is to place the anomaly-within and anomaly-between scores for a single metric on adjacent rows of the anomaly map in order to facilitate a rapid comparison between a target company's performance versus its own past compared to its performance versus the economy in its industry. An alternate approach is to have one anomaly map for the anomaly-within scores (performance versus past) and a separate anomaly map for the anomaly-between scores (performance versus industry).

Other techniques that may be used include the use of split cells. For instance, in each cell within the body of the anomaly map, the cell may be physically divided such that, for example, the left half of the cell represents the anomaly-within score and the right half the anomaly-between score, with a separate characteristic displayed in each portion. Such a technique can also be used with the cell split into separate portions vertically (top and bottom), or on an angle.

Another technique that can be used is to use different types of displayable characteristics for the anomaly-within and anomaly-between scores, and to display them in the same cell. For instance, a characteristic such as color could be associated with an anomaly-within score for a given metric and time period, and a separate characteristic, such as the size of the indicator, or the intensity of the color could be used for the anomaly-between score of the same metric and time period.

Each cell within the body of the anomaly map 100 is associated with a displayable characteristic that is associated with the value of the anomaly score corresponding to the time period and metric for that cell. Various displayable characteristics may be employed depending on the nature of the medium of presentation of the anomaly map. Examples include but are not limited to: color choice, color intensity, cross-hatching patterns, patterns of colors, scrolling or moving patterns, blinking, and such other display characteristics as would be known to those of skill in the art.

It will be understood that not every displayable characteristic is suitable for every display medium. For example, the use of blinking or moving patterns within a cell will be limited to displays, such as computer or television monitors, that are capable of displaying time-varying patterns. By contrast, more simple characteristics such as color choice and intensity are suitable for any color-capable display medium. Some patterns, such as cross hatching, are usable even in media where color is unavailable.

As can be seen in FIG. 1, cross hatching and other fill patterns have been used as the display characteristics for the illustrated anomaly map 100. In the particular embodiment illustrated, the characteristics chosen are illustrated in a legend 200. The characteristics include: solid (block 210), dotted (block 220), a single dot (block 230), empty (block 240), a single slash (block 250), cross-hatched (block 260), and doubly-cross hatched (block 270). Each of these characteristics is associated with a particular range of anomaly scores.

For example, in one embodiment, the characteristic identified with block 210 is used to represent the most highly negative range of anomaly scores and the characteristic shown in block 220 is used for scores that are less negative. The characteristic in block 230 is used for slightly negative anomaly scores. Block 240 illustrates the characteristic used for neutral scores that deviate neither significantly negatively or positively from the group norm. The characteristic shown in block 250 is used for anomaly scores that are slightly positive. Block 260 illustrates the characteristic for somewhat positive deviations, and block 270 corresponds to the characteristic used to identify highly positive deviations.

The demarcations or breakpoints between the various categories corresponding to the blocks 210, 220, 230, 240, 250, 260, 270 of the legend 200 can be varied to adjust the sensitivity of the presentation made by the anomaly map. In one embodiment, the highly negative category, illustrated by the characteristic in block 210, is used for anomaly scores that are less than −50. This is indicated by the breakpoint 280, having a value of −50, illustrated between the display characteristics for the most negative score range (block 210) and the second most negative score range (block 220).

Similarly, it can be observed that breakpoint 282 with a value of −6 separates the somewhat negative category (block 220) from the slightly negative category (block 230). Breakpoints 284, 286, 288 and 290 separate the remaining categories from one another as shown in legend 200. These six breakpoints divide the spectrum of possible anomaly scores into seven ranges that each have an associated display characteristic. Some techniques for varying these breakpoints are discussed in greater detail below.

Within the body of the heat map, the characteristic displayed within each cell represents the range into which the value of the anomaly score corresponding to that cell falls. In FIG. 1, for instance, the cell representing the anomaly score of the Net Income metric for the fourth fiscal quarter of 2003, displays a dotted characteristic. According to the legend 200, this characteristic is shown in box 220 and corresponds to an anomaly score that is in the somewhat negative range of −6 to −50.

By associating the display in each cell with a visual characteristic, an account manager or other decision maker can quickly identify what portions of the map represent positive deviations, and which represent negative deviations. Furthermore, because of the organization of the anomaly map, it is easy for the account manager to identify particular time periods (vertical groupings) that tended toward particular types of deviations, as well as particular aspects of business finance (horizontal groupings) that tended toward positive or negative deviations.

For example, in the anomaly map illustrated in FIG. 1, it can be seen that there are several positive characteristics displayed in column 180, corresponding to the time period of the second fiscal quarter of 2003. This collection of positive results forms an indication to the decision maker that there may be something that happened during this time period that resulted in significant improvement in performance, and may merit further investigation to determine whether this is truly a period of high performance, or whether such a large number of positive indications are a sign of a change in the target company's underlying financial model or reporting behavior.

Similarly, it can be seen that the horizontal grouping shown in row 130 indicates ongoing underperformance on the metric of Total Revenue for the target company over time when compared to its industry peers. A financial analyst may decide that such an indication gives a reason to look further into the revenues of this company, and the way in which these revenues are reported.

Of course, various other arrangements of characteristics associated with anomaly score ranges could be used. In general, display characteristics that allow for users of the visualization tool to rapidly grasp the direction (positive or negative) and magnitude of the anomaly score will be effective.

One alternate embodiment might substitute different characteristics for the various ranges. A variety of different mappings are possible. Several exemplary embodiments are shown in Table 1. For example, the embodiment discussed above with reference to FIG. 1 is illustrated in the third column of Table 1. Another embodiment discussed above is shown in the first column of Table 1. These mappings shown in Table 1 are not meant to be exhaustive, but simply to indicate a few of the possibilities that could be used without departing from the fundamental concept of the described techniques.

TABLE 1

| Anomaly | | | | | |
|---|---|---|---|---|---|
| Score Range | 1 | 2 | 3 | 4 | 5 |
| Highly | Dark red | Red | Solidly | Tight | Flashing |
| negative | | | filled | vertical | red |
| | | | | cross | |
| | | | | hatching | |
| Somewhat | Light red | Orange | Dotted | Loose | Red |
| negative | | | | vertical | |
| | | | | cross | |
| | | | | hatching | |
| Slightly | Pale red | Yellow | Single dot | Single | Light |
| negative | | | | vertical | red |
| | | | | line | |
| Neutral | White | Green | Blank | Blank | White |
| SlightlyX | Pale | Blue | Slash | Single | Light |
| positive | green | | | horizontal | green |
| | | | | line | |
| Somewhat | Light | Indigo | Cross | Loose | Green |
| positive | green | | hatching | horizontal | |
| | | | | cross | |
| | | | | hatching | |
| Highly positive | Dark | Violet | Double | Tight | Flashing |
| | green | | cross | horizontal | green |
| | | | hatching | cross | |
| | | | | hatching | |

As shown in the table, possible display characteristics can include characteristics that are most effective on displays such as computer screens, television monitors, or other dynamic display media. These include such characteristics as: flashing indicators, variations in the speed at which an indicator flashes, moving patterns (such as a scrolling marquee style display within a cell), alternating patterns (such as a cell that flashes between red and yellow), and compound indicators that make use of more than one type of characteristic in a single cell (for instance a number or cross-hatch pattern indicated in a colored cell, or a cell that alternates between two different colors).

While such characteristics can be effective at placing more information within a single cell of the anomaly map, it is desirable that the anomaly map present the information in a way that allows it to be easily understood and accessed by the decision maker. As a result, it may be the case that the use of compound display characteristics will be better suited to items that deserve special attention, rather than areas where subtle discrimination is called for.

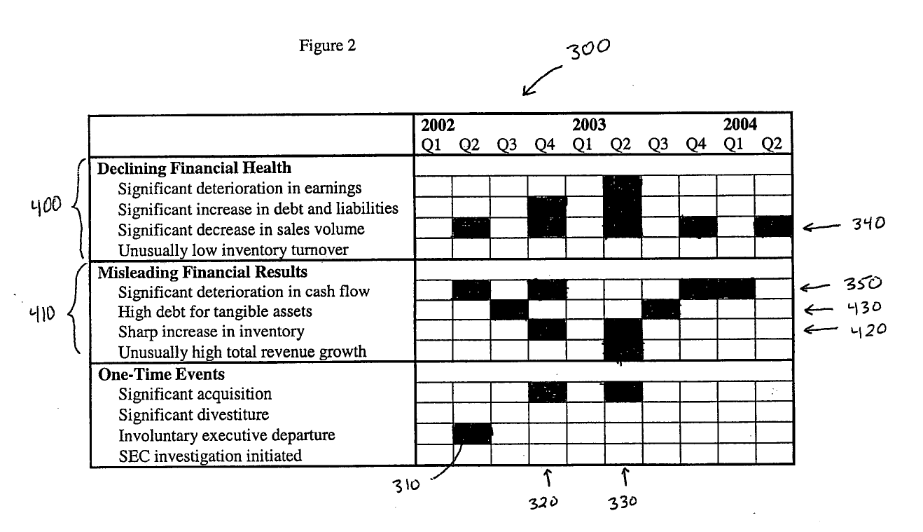

Another type of visualization that can be used to direct the attention of an account manager or other decision maker is illustrated in FIG. 2. While similar in overall layout to the anomaly map shown in FIG. 1, the visualization tool shown in FIG. 2 presents a map of “red flags” or warning signs that are present within the financial metrics for the target company.

The warnings being shown in the map in FIG. 2 differ from the anomaly scores mapped in FIG. 1 in that each cell does not represent an anomaly score, but rather a warning that is based upon a combination of factors. The factors may include both particular anomaly scores and single-time events, for example a significant change in management or the acquisition of a business. These warning indicators are referred to as ‘red flags’.

A red flag represents an aggregation of anomaly scores for multiple related financial metrics. For example, a red flag might be triggered in the event of anomalously high revenue combined with anomalously high inventory value. By combining the individual metrics, the decision to signal a red flag will be based on bringing together information from several sources, which will increase the likelihood of catching an actual event deserving of attention.

Red flags differ from anomaly scores in that a red flag either occurs during a particular time period or does not, but there is no quantity associated with the flag. Because the basis for red flags may include one-time events and other non-numeric data, statistical analysis like that used in generating anomaly scores is less effective. As a result, there is no need for a legend mapping various levels of red flag values to different display characteristics. There is a simply a single symbol or display characteristic that is used in a cell to indicate that the particular red flag is raised for the indicated time period. In FIG. 2, such indications are shown on the red flag map 300 by solidly filled in cells (for example 310).

A red flag may also be useful for presenting direct indicators for single-time events. For example, when examining the occurrence of infrequent events such as FTC or SEC investigations, management changes, mergers or acquisitions, or other one-time or rare events, it is often simply effective to indicate whether or not such an event occurred within a particular time period.

This can be done by placing a recognizable display characteristic in the body of a red flag map 300, as shown in FIG. 2, in the column corresponding to the time period in which the event corresponding to the row of the map occurred. For instance, if a director or executive was removed from office during the second quarter of 2002, this would be shown by an indication in cell 310 in FIG. 2.

This can be seen on FIG. 2. The overall structure of the map is similar to FIG. 1 in that it includes columns that represent time periods and rows that represent individual red flags, with the body of the map consisting of cells that represent the presence or absence of a particular red flag for a particular time period. However, as noted above, the cells in the red flag map are simply associated with display characteristics to represented whether a flag exists, or not. Unlike the anomaly map, there is no need for a spectrum of display characteristics representing a series of ranges along a continuum.

In the illustrated embodiment, a solidly filled cell indicates the presence of a red flag, and an empty cell represents the absence of a flag. Another characteristic that can be used to indicate a red flag is a red cell, when a color display medium is used. As discussed above with respect to the various possible display characteristics for anomaly score ranges, it is possible to use a wide variety of display characteristics as are known in the art in order to indicate the presence or absence of a red flag, including all of the various characteristics noted above for use with anomaly map visualizations.

As in the anomaly map visualization, vertical groupings of flags can be rapidly identified as showing a time period in which there were multiple red flags to be noted (see columns 320 and 330 for example), while horizontal groupings illustrate persistent occurrence of a single red flag (see rows 340 and 350 for example).

In addition to horizontal groupings in a single row showing persistent flags for the same type of event, the arrangement of the red flags into rows can be used to draw the appropriate attention of an analyst. By arranging the rows such that the red flags for related aspects of financial analysis are located closer together than the red flags for unrelated aspects of the target company's finances, it is possible to more rapidly identify those general areas in which red flags are occurring and deserve further investigation.

For example, as seen in FIG. 2, the red flags associated with warnings for various types of declines in financial health can be arranged near each other (group 400), while a separate group of red flags associated with warnings for various types of misleading financial measures are grouped together (group 410). By grouping the red flags in this way, it is possible to see when a particular general type of warning is of more importance.

For example, as can be seen in row 420, the red flag associated with a sharp increase in inventory is indicated in various periods—illustrated in the body of the map of red flags by the “filled in” display characteristic. In row 430, the map indicates that the red flag for unusually high debt given tangible assets is also illustrated sporadically over time, and not always in the same time periods as the red flags in row 420. Both of these red flags are related to misleading financial warning signs, and both are associated with the assets of the company, either tangible assets or inventory. By locating these indicators in rows that are disposed within the map close to each other, an overall pattern of potentially misleading financial data associated with assets can be seen. If these red flags were located in widely separated rows, the overall pattern would seem much less coherent and related.

In an alternative embodiment, rather than grouping related red flags together, the red flags are ranked with respect to the frequency with which each one occurs. In this embodiment, those red flags occurring most frequently are placed at the top of the map and those red flags occurring infrequently or not at all are placed at the bottom of the map. Although useful in assisting the analyst to quickly assess the most chronic problems, this placement becomes difficult to quickly assimilate since the order of the red flags is no longer fixed.

As a result, effective placement of rows for red flags that are related or associated with one another helps to create groupings of related red flags that more easily draw the attention of the decision maker when the red flag map is viewed. In essence, the same amount of overall indicated variation is more significant if it is arranged in a way that suggests a coherent pattern, rather than simple random occurrences. By arranging the rows in such an ordered manner, such patterns are more easily detected visually and can be investigated more effectively.

The techniques and systems described herein can be used to provide an advantage to an account manager or other user who is tasked with evaluating the risks associated with a business transaction with a target company based upon its financial history. At their simplest, the visualizations presented herein provide a way for rapidly assessing the overall degree of anomalousness associated with a given target company's financial performance. However, the appropriate use and understanding of the techniques discussed herein allows a greater appreciation of the nature and significance of any anomalous financial performance by the target company.

One example of such information is that the visualizations discussed herein provide a way to rapidly identify the frequency or persistence of anomalies, particularly if a single anomaly shows up consistently in the absence of other anomalous behavior. Such an observed pattern in the visualization focuses the attention of the decision maker on the particular anomaly for that company, rather than industry or the particular time period.

Another example of a rapidly identifiable pattern would be if a number of anomalous results were all observed in a single time period in an otherwise non-anomalous visualization. Such indications direct the attention of the decision maker to the occurrences of that particular time period.

Such visualizations that indicate the direction, severity, and chronology of various anomalous behavior allow for the decision maker to more rapidly assimilate and comprehend the nature of the financial behavior of the target company. Patterns of anomalies may also be used as indicators of larger financial behaviors, e.g. anomalous results in a particular pattern may indicate a general trend of aggressive revenue recognition within a particular company, or indicate that there is a tendency to overstate the quality of the company's earnings, or to overvalue intangible assets in order to protect the bottom line. Such patterns of “anomaly signatures” can be recognized visually based on the way that anomalies cluster over time and in particular rows.

Another advantage is that the visualizations can be used to provide a way for the decision maker to rapidly access further supporting information that may be useful in properly understanding the underlying causes and significance of anomalous financial results. For instance, each block on an anomaly map can be associated with a link to supporting information that corroborates the result identified in that block.

For example, in an anomaly map that was displayed using an interactive medium, such as a computer, a hot link using HTML or another markup language can be used to access supporting data or further details. If the anomaly map of FIG. 1 were displayed, clicking on cell 190 could provide a hotlink to the underlying financial information that was used to calculate the anomaly score associated with the financial metric of intangible assets for the third fiscal quarter of 2002. By providing rapid access to such data, the map gives the decision maker the ability to drill down into the underlying supporting data rapidly and make a further evaluation as to the importance or scope of the anomaly score indicated on the anomaly map.

A similar technique can be used on a red flag map by linking blocks associated with each red flag to appropriate supporting data. This could include material such as press releases indicating one-time events (such as management changes), and links to the underlying financial metrics for red flags that are associated with collections of individual anomaly score results. With such links in place, these visualizations can be used as an anomaly exploration tool with which to browse a company's financial status and history as characterized by its financial anomalies, financial trends, and company behavior patterns.

In general, such visualizations allow decision makers to analyze the financial behavior of a target company for a potential business transaction. For instance, two companies may have the same amount of their overall financial results within the last three years that would be considered anomalous, but the way that those anomalous metrics are distributed can be different in ways that dramatically impact the overall financial risk associated with the company.

For instance, a company with a moderate amount of slightly negative and slightly positive anomalies scattered throughout its anomaly map might be presumed to be experiencing normal variations and drift due to market forces or other vagaries of the economy. On the other hand, the same number of anomalies concentrated within one or two fiscal periods indicates something else entirely. It is much more likely that there were particular events or strategies that resulted in anomalous behavior localized at those times.

Even in the case where most of the anomalies are found in one or two time periods, the impression of the company may be different if those anomalous results are recent as opposed to if they are more remote in time. A company that showed anomalous behavior at a particular time and then shows no anomalous financial results since that time appears to have taken corrective action. On the other hand, anomalous results that continue to the current time may indicate behavior that still requires correction.

Similarly, if the same amount of anomalous behavior is found consistently over time, but only in some metrics, then there may well be a reason to investigate the performance associated with these metrics in more depth. It could be the case that such a set of anomalies is consistently observed because that anomaly is endemic to that particular target company, or it may be the case that there is consistent poor financial management with respect to those issues at that company.

In addition to the embodiments described above, other embodiments may include additional or alternate aspects, as described below. For example, in one other embodiment of the systems and techniques provided herein, a facility to vary the breakpoints between the various levels of associated display characteristics can be provided. Such a feature can be used to allow the user to select the level of anomaly score at which a particular cell will switch from one display characteristic to another. For example, rather than having the display characteristic illustrated in block 210 of FIG. 1 be associated with anomaly scores that are less than −50, the break point 280 between the display characteristics for block 210 and 220 could be altered to be an anomaly score of −100.

Such a change would result in a greater number of cells falling into the range of scores corresponding to block 220, and a smaller number falling into the range corresponding to block 210. By altering the breakpoints in this way, there will be less of the most extremely negative display characteristic displayed.

Note that this change does not change the underlying anomaly score calculations, but only the display characteristic that is associated with any particular resulting anomaly score. In general, by altering these breakpoints (280, 282, 284, 286, 288, 290), it is possible to increase the ability of the user to distinguish between particular anomaly score ranges of interest.

In addition to presenting the user with the ability to alter each of the breakpoints between the display characteristics in the legend 200, a more general and broad control over the center point and sensitivity of the display may be provided through the use of a pair of user controls.

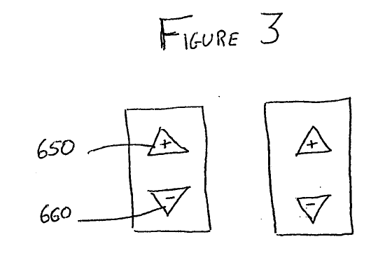

One such example is shown in FIG. 3. Illustrated is a pair of user controls, in this particular instance a pair of up/down buttons (one for each control) that are used to change the center of the range for the display characteristics and the sensitivity of the display.

In the example discussed above with respect to FIG. 1, the range of display characteristics is centered at an anomaly score of 0. This means that a score of zero falls within the middle of the available display characteristics, and that an equal number of characteristics are available both above and below this point for use in distinguishing between anomaly scores. By hitting the ‘up’ button 650, the center of the display characteristic range can be increased. Conversely, hitting the ‘down’ button 660 will decrease the center of the range. This has the effect of simultaneously increasing all of the breakpoints (280-290), or simultaneously decreasing all of the breakpoints.

Altering the center of the display range can be useful to get a better view of a particular company's anomaly map that has more values to one side of the current center point than the other. For example, if an account manager wished to get a more clear view of the financial metrics of a company where the majority of the anomaly scores were negative, skewing the center of the display range downward would make use of more of the effective range available to differentiate between the varying degrees of negative scores.

The sensitivity adjustment operates in a similar way to the center point adjustment in that it is used to adjust the breakpoints between the ranges associated with each display characteristic. However, instead of shifting all the breakpoints the same way, the sensitivity adjustment allows a user to change the size of each range associated with a particular display characteristic. For example, in FIG. 1, the size of the range associated with each of the central three characteristics (blocks 230, 240 and 250) is a difference of 4 in the anomaly scores (−6 to −2 for block 230; −2 to 2 for block 240; and 2 to 6 for block 250). By adjusting the sensitivity, this range could be made smaller or larger. This allows for trading the discriminating power of the available display characteristics against the size of the ranges.

For example, to allow more discrimination between similar anomaly scores, the sensitivity is increased, making the ranges smaller, and allowing for finer visual discrimination between anomaly scores. The trade off is that more scores will be pushed into the more extreme categories, resulting in less significance to the display characteristics associated with the most extreme anomaly scores.

By varying these breakpoint parameters, the visualization tool can be tuned to view particular anomaly maps in a manner that provides for the most useful decision making analysis for the account manager or other financial analyst.

It will also be understood by those of skill in the art that in addition to the buttons 650, 660 shown in FIG. 3, that other means of adjusting the centering and sensitivity are possible in other embodiments. These can include controls that imitate knobs or sliders, or buttons that select from among a preset group of breakpoint arrangements. In addition, it will be understood that in still other embodiments the user, rather than using adjustments for sensitivity and centering to adjust the breakpoints collectively, could individually adjust each breakpoint.

In another embodiment of the visualization tools presented herein, it is possible to use a different number of display characteristics than are discussed above and illustrated in FIG. 1. For example, although FIG. 1 illustrates a legend that provides for seven different display characteristics associated with a range of anomaly scores, there is no need to limit the number of displayable ranges to seven. Anomaly maps can be produced using any desired number of ranges, so long as a suitable variety of display characteristics are available.

If display characteristics that can be varied continuously (or nearly continuously) are available (such as the brightness of a color, or the speed of a moving pattern), then an effectively infinite number of levels can be made available. In such circumstances, the display characteristic is related in some way directly to the particular anomaly score, rather than being grouped into a single range, all of which is displayed in the same manner. It will be understood to those of skill in the art that such continuously variable display characteristics will be more effective on certain types of display media than others. For instance, anomaly visualizations that are transmitted by facsimile or presented in monochrome are less well suited to continuous variations in color or shading than visualizations that will be viewed directly on color displays.

Another embodiment makes use of a separate anomaly map for the anomaly-within and the anomaly-between visualizations, and allows a user to toggle between the two displays. If such a display is used and the time periods and financial metrics are located in the same places on both the anomaly-within and anomaly-between maps, this technique can draw an analyst's attention to those areas where the performance of the target company differs when compared to its past versus when compared to its peers. Such deviations will show up as cells that change their displayed characteristic dramatically when the views are toggled. For instance, if using a color mapping scheme such as the scheme in column 1 of Table 1, cells that change from a red hue to a green hue when the visualizations are toggled are cells with that indicate good performance in one comparison and poor performance in the other.

In a further embodiment of the systems and techniques for anomaly visualization, it is also possible to include a display characteristic that is associated with cells in a map for which no evaluation was made. This can be useful in circumstances where, for example, data for some time periods is unavailable for a particular target company or its peers, red flag calculations that require unavailable data, or such other circumstances when a calculation cannot be made.

Examples of display characteristics that can be used for such “no test” cells can include a single slash or an “X” through a cell, or the use of a neutral color, such as gray. The choice of display characteristic is not limited in any way, but may be most effective when chosen to contrast with all of the other display characteristics in use in the legend of that particular visualization.

The use of such “no test” characteristics allows a decision maker to distinguish between financial records that were examined and produced no red flags or anomalous results, and financial results that are simply unknown. This prevents inadvertent conclusions that everything is non-anomalous in a particular time period when the truth is that there is no data to support a conclusion either way.

In addition to the embodiments described above with reference to financial metrics and financial analysis, it will be appreciated that the general analysis and visualization systems and techniques described herein may also be used in the context of other types of analysis of performance metrics. Such contexts could include, without limitation: medical studies, television ratings, real-estate pricing, insurance estimating, athletic performance monitoring, equipment reliability improvement, and health care monitoring.

For example, the use of anomaly maps may be effective in analyzing a patient's health and identifying anomalous areas in which a doctor might focus his examination of a patient. For instance, if blood pressure were to be monitored and recorded periodically for a large group of patients, it would be possible to identify, even in the absence of pre-defined normal values, anomalous results for a patient when compared to his own history, as well as to the results of his peers. In one instance, it might be observed that a patient's blood pressure was consistently rising over a period of time. However, such a gradual rise might not be anomalous when compared to the blood pressure of the individual's peers, all of whom might be experiencing increasing blood pressure of a non-anomalous nature, simply due to aging. Such a result could be quickly identified through the use of an anomaly map as described above where blood pressure was a performance metric associated with the target entity of the patient, and where other patients with similar demographic characteristics (for example, age and gender) formed the peer group. By comparing the anomaly-within and anomaly-between maps, a doctor or other medical practitioner could more rapidly identify those aspects of the patient's health metrics that deserved further attention and those that simply represented ordinary variation.

The various embodiments of anomaly visualizations and the techniques for creating and using them described above thus provide a way for analysts such as account managers and financial analysts to evaluate the target entity. These techniques and systems also provide a way to compare companies and to evaluate the risk associated with business transactions with target companies.

Of course, it is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

Furthermore, the skilled artisan will recognize the interchangeability of various features from different embodiments. For example, the use of links in cells to provide access to underlying data described with respect to one embodiment can be adapted for use with the sensitivity and centering adjustments described with respect to another. Similarly, the various features described, as well as other known equivalents for each feature, can be mixed and matched by one of ordinary skill in this art to construct visualization techniques and systems in accordance with principles of this disclosure.

Although the systems herein have been disclosed in the context of certain embodiments and examples, it will be understood by those skilled in the art that the invention extends beyond the specifically disclosed embodiments to other alternative embodiments and/or uses of the systems and techniques herein and obvious modifications and equivalents thereof. Thus, it is intended that the scope of the invention disclosed should not be limited by the particular disclosed embodiments described above, but should be determined only by a fair reading of the claims that follow.

What is claimed is:

1. A method for displaying a plurality of anomaly measures associated with a target entity, each of the plurality of anomaly measures being associated with a performance metric and a time period, the method comprising:
determining a value for an anomaly score for each performance metric and time period for the target entity;
determining a set of ranges of anomaly score by selecting a set of breakpoints, such that the range of possible anomaly scores is divided into a set of ranges such that each range in the set is separated from an adjacent range by a breakpoint;
associating a displayable characteristic with each of the set of ranges of anomaly scores;
assigning a displayable characteristic to each anomaly score based upon the range that the value of the anomaly score falls into;
associating each assigned displayable characteristic with a cell of a grid of cells, the grid having rows and columns of cells where all the cells in a single row or column of the grid correspond to either the same performance metric or the same time period; and
presenting the data to a user on a display medium.

2. A method as in claim 1 wherein the target entity comprises a target company and the performance metric comprises a financial metric.

3. A method as in claim 1 wherein determining a value for an anomaly score comprises:
identifying a target value, the target value being the value of the performance metric associated with the target entity for the time period;
collecting context data based upon the target entity; and
calculating an anomaly score using the target value and the context data using an exceptional statistical measurement.

4. A method as in claim 3 wherein the context data comprises performance metric data for the target entity for other time periods.

5. A method as in claim 3 wherein the context data comprises the value of the performance metric for each of a group of peer entities.

6. A method as in claim 5 wherein the peer entities are in the same taxonomic classification as the target entity.

7. A method as in claim 3 wherein calculating an anomaly score further comprises:
generating a measure of central tendency for the target value and context data using an exceptional technique;
generating a measure of variation for the target value and context data using an exceptional technique; and
generating an anomaly score based upon the measure of central tendency, the measure of variation, and the target value.

8. A method as in claim 7 wherein generating an anomaly score is done using an equation of the form
$$A = \frac{Xt - CT}{V}$$
Where A is the anomaly score, Xt is the target value, CT is the measure of central tendency, and V is the measure of the variation.

9. A method as in claim 1 wherein the values of the breakpoints can be adjusted in order to change the displayable characteristics associated with at least one of the anomaly measures.

10. A method as in claim 9 wherein the breakpoints can be adjusted collectively upwards or downwards in order to adjust the center of the set of ranges.

11. A method as in claim 9 wherein the breakpoints can be adjusted collectively to be closer together or farther apart in order to adjust the size of the set of ranges.

12. A method as in claim 1 wherein each cell of the grid is associated with a display of supporting material associated with the determination of the anomaly score associated with that cell.

13. A method as in claim 12 wherein the display medium is interactive, and selecting a cell in the grid causes the display medium to display the supporting material associated with that cell.

14. A visualization of a set of anomaly measures associated with a target entity, each of the set of anomaly measures being associated with a performance metric and a time period, the visualization comprising:
a grid of cells on a display medium arranged into rows and columns where each cell belongs to one row and one column, and where each cell in a single row or column corresponds to either the same performance metric or the same time period, and where each cell is associated with an anomaly score corresponding to the performance metric, time period and target entity associated with that cell;
a set of ranges of anomaly scores that are separated from one another by a set of breakpoints such that each range in the set of ranges is separated from an adjacent range by a breakpoint and all possible anomaly scores fall into one of the set of ranges; and
a set of displayable characteristics wherein each of the set of characteristics is associated with one of the set of ranges of anomaly scores, and the displayable characteristic associated with each cell is displayed on the display medium at the location of the cell.

15. A visualization as in claim 13 wherein the target entity comprises a target company and the performance metric comprises a financial metric.

16. A visualization as in claim 14 wherein the anomaly score is determined by:
identifying a target value, the target value being the value of the performance metric associated with the target entity for the time period;
collecting context data based upon the target entity; and
calculating an anomaly score using the target value and the context data using an exceptional statistical measurement.

17. A visualization as in claim 16 wherein calculating an anomaly score further comprises:
generating a measure of central tendency for the target value and context data using an exceptional technique;
generating a measure of variation for the target value and context data using an exceptional technique; and
generating an anomaly score based upon the measure of central tendency, the measure of variation, and the target value.

18. A visualization as in claim 17 wherein generating an anomaly score is done using an equation of the form
$$A = \frac{Xt - CT}{V}$$
Where A is the anomaly score, Xt is the target value, CT is the measure of central tendency, and V is the measure of the variation.

19. A visualization as in claim 14 wherein the values of the breakpoints can be adjusted in order to change the displayable characteristics associated with at least one of the anomaly measures.

20. A visualization as in claim 19 wherein the breakpoints can be adjusted collectively upwards or downwards in order to adjust the center of the set of ranges.

21. A visualization as in claim 19 wherein the breakpoints can be adjusted collectively to be closer together or farther apart in order to adjust the size of the set of ranges.

22. A visualization as in claim 14 wherein each cell of the grid is associated with a display of supporting material associated with the determination of the anomaly score associated with that cell.

23. A visualization as in claim 22 wherein the display medium is interactive, and selecting a cell in the grid causes the display medium to display the supporting material associated with that cell.
